(19) United States
(12) Patent Application Publication
(10) Pub. No.: US 2009/0116484 A1
(43) Pub. Date: May 7, 2009

(54) Parallelizing Peer-to-Peer Overlays Using Multi-Destination Routing

(75) Inventor: John Buford, Lawrenceville, NJ (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 11/991,633

(22) PCT Filed: Sep. 8, 2006
(86) PCT No.: PCT/US2006/035116

§ 371 Date: Mar. 6, 2008

Related U.S. Application Data
(60) Provisional application No. 60/715,388, filed on Sep. 8, 2005.
(60) Provisional application No. 60/716,383, filed on Sep. 12, 2005.

(51) Int. Cl. H04L 12/56

(52) U.S. Cl. 370/392

(57) ABSTRACT

A method is provided for parallelizing overlay operations in an overlay network. The method includes: identifying an overlay operation having a parallel messaging scheme; determining a destination address for each parallel message in the messaging scheme; encoding each destination address into a data packet; and transmitting the data packet over the overlay network using a multi-destination, multicast routing protocol.

### CROSS-REFERENCE TO RELATED APPLICATIONS

This application claims the benefit of U.S. Provisional Patent Application No. 60/715,388 filed on Sep. 8, 2005 and U.S. Provisional Application No. 60/716,383, filed on Sep. 12, 2005. The disclosure of the above applications are incorporated herein by reference.

### FIELD

The present disclosure relates to peer-to-peer overlay networks and, more particularly, to a method for parallelizing overlay operations in an overlay network.

### BACKGROUND

An overlay network is a network which is built on top of another network. Nodes in the overlay network can be thought of as being connected by logical links, each of which corresponds to a path in the underlying network. Many peer-to-peer networks are implemented as overlays networks running on top of the Internet. Traditionally, overlay networks have relied upon unicast messaging to communicate amongst the nodes.

More recently, host group multicast has been proposed for overlay messaging operations. Briefly, host group multicast protocols create a group address, and each router stores state for each group address that is active. The state in the router grows as the number of simultaneous multicast groups. There is delay to create a group, and the network may have a limited number of group addresses.

For a large overlay network, it is impractical for each node to have a group address for each set of other nodes it sends messages to. There would be too much traffic and router overhead if each node maintained multicast addresses for all or many subsets of the overlay network, due to the large number of nodes involved.

In addition, if a peer node wants to use native host-group multicast to issue parallel queries to a set of nodes, it must first create the state in the routers and bring the receivers into the multicast. This setup adds delay and is only appropriate if the multicast path is going to be re-used for some time. However, in peer-to-peer networks the set of nodes is fairly dynamic and the set of requests between nodes is not predictable, so re-use of such multicast groups is limited.

Host group multicast is designed for relatively small numbers of very large sets of recipients. So host group multicast is not a good choice for use in parallelizing network overlay operations where there are many simultaneous small groups of peers involved in a message. Therefore, there is a need for parallelizing overlay operations in an overlay network.

The statements in this section merely provide background information related to the present disclosure and may not constitute prior art.

### SUMMARY

A method is provided for parallelizing overlay operations in an overlay network. The method includes: identifying an overlay operation having a parallel messaging scheme; determining a destination address for each parallel message in the messaging scheme; encoding each destination address into a data packet; and transmitting the data packet over the overlay network using a multi-destination, multicast routing protocol.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary network configuration having an overlay network;

FIG. 2 is a flowchart illustrating an exemplary method for parallelizing overlay operations in an overlay network;

FIG. 3 is a diagram of a portion of an overlay network;

FIGS. 4A-4B are diagrams illustrating how the used to describe the multi-destination, multicast routing protocolsegmentary

FIG. 5 is a diagram illustrating a node lookup in a Kademlia overlay network;

FIG. 6 is a diagram illustrating an event detection and reporting algorithm; and

FIGS. 7A and 7B are diagram illustrating a conventional scheme for traversing a multicast tree and a proposed messaging scheme which relies upon a multi-destination, multicast routing protocol, respectively.

The drawings described herein are for illustration purposes only and are not intended to limit the scope of the present disclosure in any way.

### DETAILED DESCRIPTION

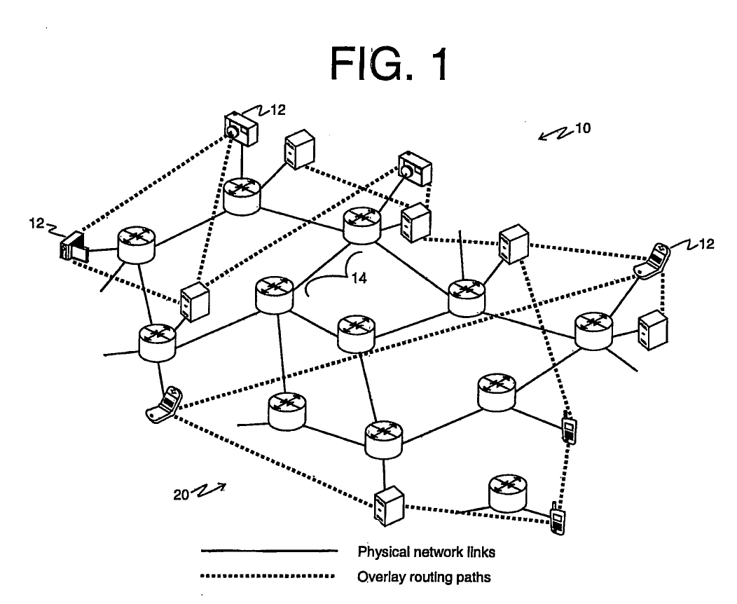

FIG. 1 is a diagram of an exemplary network configuration having an overlay network. Briefly, the underlying network 10 is generally comprised of a plurality of network devices 12 interconnected by a plurality of network routing devices 14 (i.e., routers). The physical network links between these devices are indicated by the solid lines in the figure. An overlay network 20 is built on top of the underlying network 10. The overlay network 20 is a series of logical links defined between devices and indicated by the dotted lines in the figure. Exemplary overlay network architectures include Content Addressable Network (CAN), Chord, Tapestry, Freenet, Gnutella, and Fast Track. It is readily understood that this disclosure pertains to other types of overlay network architectures.

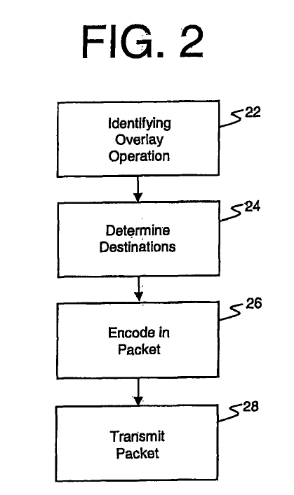

FIG. 2 illustrates a method for parallelizing overlay operations in an overlay network. First, a suitable overlay operation is identified at 22. Exemplary overlay operations may include but are not limited to a node joining the overlay; a node leaving the overlay; routing table updates; a node forwarding routing tables or routing table excerpts to other nodes; a node exchanging node state and/or overlay measurements with another node; a node sending a request to several other nodes; and a node publishing an event to several subscriber nodes. Some of these operations will be further described below. It is readily understood that this method applies to other overlay operations having parallel messaging schemes (i.e., at least two unicast messages sent from one source node to multiple destination nodes).

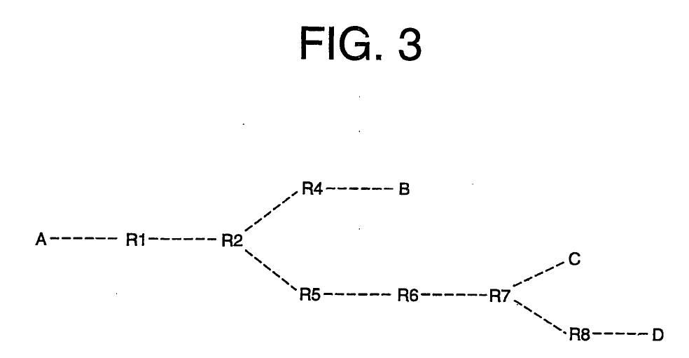

Multi-destination, multicast routing is then used to transmit an applicable message over the overlay network. In general, the source node determines a list of destinations for the message 24 and encodes each destination address 26 into the header of a single data packet. In an overlay network, the destination addresses for such messages are typically known to the source node. With reference to FIG. 3, assume node A is trying to send messages to nodes B, C and D. Node A encodes the data packet header as follows: [src=A|dest=B C D|payload]. The data packet is then sent 28 from the source node.

Multicast-enabled routers along the transmission path will in turn forward the data packet on to its destinations. Upon receiving the data packet, a multicast-enabled router processes the data packet as follows. For each destination address in the data packet, the router performs a route table lookup to determine the next hop. For each different next hop, the data packet is replicated and then the list of destinations is modified so that each data packet only contains the destination addresses which are to be routed through the next hop associated with the data packet. Lastly, the modified data packets are forwarded by the router to the applicable next hop(s).

In FIG. 3, router R1 will forward a single data packet having a destination list of [B C D] to router R2. When router R2 receives the data packet, it will send one copy of the data packet to router R4 and one copy of the data packet to R5. The data packet sent to router R4 has a modified destination list of B. On the other hand, the data packet sent to router R5 will have a modified destination list of [C D]. This data packet will be forwarded on by routers R5 and R6 until it reaches router R7. At router R7, the data packet will again be partitioned into two data packets, each packet having destinations of C and D, respectively. It is readily understood that data packets having a single destination may be unicast along the remainder of their route.

Explicit Multicast (Xcast) protocol is an exemplary multi-destination, multicast routing protocol. Further details regarding the Xcast protocol may be found in Explicit Multicast Basic Specification as published by the Internet Engineering Task Force and which is incorporated herein by reference. However, it is readily appreciated that other multi-destination, multicast routing protocols are within the scope of this disclosure.

In one exemplary embodiment, the multi-destination, multicast. routing protocol is implemented at an application level of the source node. In other words, the application performing the overlay operation identifies those operations having parallel messaging schemes and transmits the message(s) accordingly.

In another exemplary embodiment, each peer pᵢ has a queue Q which has pending messages to send. The messages in the queue may be unicast messages or multicast messages. The multicast messages may have been added directly by the overlay operations implemented in the peer or may have resulted from combining messages during prior processing of the contents of Q.

After adding a unicast message to Q, the peer examines Q and may combine a set u of unicast messages to create a multicast message mₖ to group gₖ where mₖ contains the contents of the unicast messages, pⱼεgₖ, |gₖ|=|u|+1, and gₖεFₗ, where pᵢ is a given peer and Fᵢ is the set of all combinations of sets of peers in the overlay of size i=2, 3, . . . , n. The peer may flush one or more messages from the queue, combine other unicast/multicast messages, and/or wait for further messages. The peer acts to maintain the maximum queuing delay of any message below a threshold d_{q}. Other criteria which prevents multicasting a message includes: has the packet reached a size limit on its payload; has the packet reached a size limit on its list of destination addresses; has the packet reach a processing limit related to time or peer resources needed to construct it, store it, receive it, and process it; has the packet reached a time delay related to how long the message can remain in the queue prior to being transmitted; or do the contents of the messages being combined into the multicast message completely overlap, partially overlap, or have no overlap (the more overlap, the more efficiency gain in using multicast).

Assume peers agree on the rules for combining and extracting unicast messages to/from multicast messages. Assume that the decision criteria used at the Q to combine messages considers that the benefits of multicast for network efficiency is proportional to the amount of overlap of the content of the combined unicast messages.

Multicast routing offers efficiency and. concurrency to overlay designers. However it is necessary that: first, the scalability of the multicast algorithm for number of groups meets the scalability requirements of the overlay. If C is the capacity of the network to support simultaneous multicast group state for this overlay, then N_{G}≦C. Likewise, if v is the maximum group size, then |gₘₐₓ|<v. Second, the overlay's rate r of group formation and group membership change be attainable by the multicast mechanism. The time to create a new multicast group t_{c}<d_{q}.

This methodology assumes that the underlying network employs multicast-enabled routers. In many situations, this is a valid assumption. In other instances, only a subset of the routers in the underlying network is multicast-enabled. In these instances, the multicast-enabled routers use special tunnel connections to transmit data packets amongst themselves.

In yet other instances, the underlying network does not provide any multicast-enabled routers. In these instances, special computers may be deployed nearby other routers in the underlying network. These computers would be configured to implement the routing protocol described above, thereby forming a logical multicast backbone. A source node wanting to send a multicast packet sends the packet to the nearest computer in the logical multicast backbone which in turn routes the packet over the logical multicast backbone to its destinations.

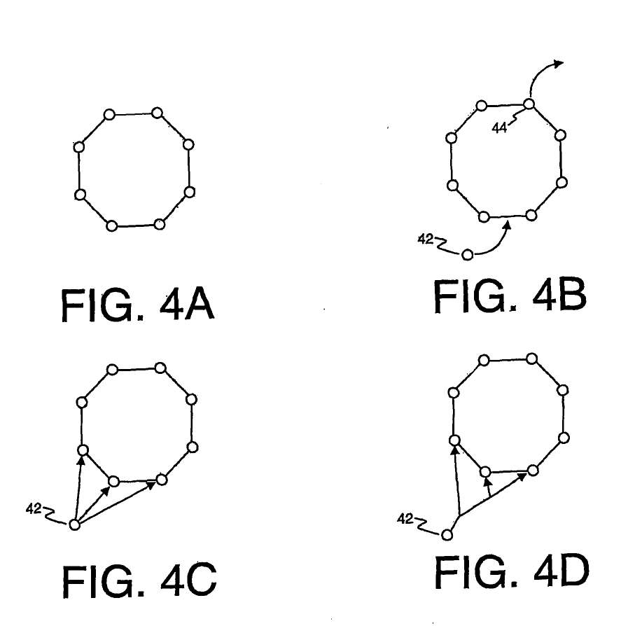

How this methodology may be applied to particular overlay operations is further described below. FIG. 4A shows the current state of the of an exemplary overlay network. However, since a peer-to-peer environment tends to be dynamic, a node 42 may join the network while another node 44 leaves the network as shown in FIG. 4B. To do so, an incoming or departing node must communicate its change in status to the other nodes in the network. For instance, an incoming node may unicast request messages to multiple nodes in the network as shown in FIG. 4C. Rather than sending multiple unicast messages, the incoming node may send a single packet using multi-destination, multicast routing as shown in FIG. 4D. It is understood that different types of overlay networks employ different messaging schemes for communicating amongst nodes. Nonetheless, these types of overlay operations are particularly suited for parallelization in the manner described above.

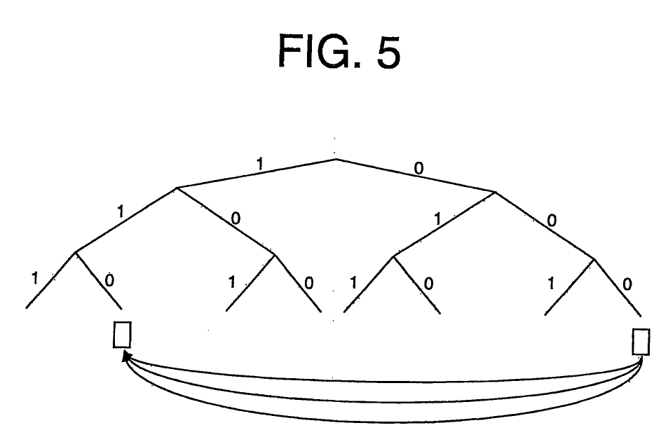

Kademlia is a multi-hop overlay that by virtue of its symmetric distance metric (the XOR function) is able to issue parallel requests for its routing table maintenance, lookups and puts. During a node lookup, a peer computes the XOR distance to the node, looks in the corresponding k-bucket to select the α-closest nodes that it knows of already, and transmits parallel requests to these peers. Responses return closer nodes. Kademlia iteratively sends additional parallel requests to the α-closest nodes until it has received responses from the k-closest nodes it has seen. A typical value of α is 3. FIG. 5 shows a node lookup for a node in the 110 k-bucket. For a 160-bit address space there will be up to 160 buckets.

Node lookup is used by other Kademlia operations including DHT store, DHT refresh, and DHT lookup. A Kademlia peer does at least k/α iterations for a node lookup in a given bucket. For k=20 and α=3, that is 3-way queries to seven multicast groups. With 160 buckets, each peer would need at least 160 groups to do queries across its address space. If the multicast queries were α-way, the Chuang-Sirbu scaling law estimates a 18% savings using multi-destination, multicast routing, and if the queries were k-way, k=20, Chuang-Sirbu estimates a 42% savings from multicasting Kademlia requests in the manner described above, although responses would be unicasted.

Meridian is a measurement overlay in which relative distance from other nodes in the overlay is used for solving overlay lookups like closest node discovery and central leader election. Each peer organizes its adjacent nodes into a set of concentric rings, each ring contains k=O(log N) primary entries and I secondary entries. In simulation of N=2500 nodes, k=16, number of rings i*=9. Meridian uses a gossip protocol to propagate membership changes in the overlay. During a gossip period, a message is sent to a randomly selected node in each of its rings. The message contains one node randomly selected from each of its rings. Unicast gossip messages can be multicast in the manner described above to i* destinations using a single i*-way message.

In EpiChord, peers maintain a full-routing table and approach 1-hop performance on DHT operations compared to the O(log N) hop performance of multi-hop overlays, at the cost of the increased routing table updates and storage. An EpiChord peer's routing table is initialized when the peer joins the overlay by getting copies of the successor and predecessor peers' routing table. Thereafter, the peer adds new entries when a request comes from a peer not in the routing table, and removes entries which are considered dead. If the churn rate is sufficiently high compared to the rate at which lookups add new entries to the routing table, the peer sends probe messages to segments of the address space called slices. Slices are organized in exponentially increasing size as the address range moves away from the current peer's position. This leads to a concentration of routing table entries around the peer, which improves convergence of routing.

To improve the success of lookups, EpiChord uses p-way requests directed to peers nearest to the node. During periods of high churn, a peer maintains at least 2 active entries in each slice of its routing table. When the number of entries in a slice falls below 2, the peer issues parallel lookup messages to ids in the slice. These parallel lookup messages may be sent using multi-destination, multicast routing in the manner described above. Responses to these lookups are used to add entries to that slice in the routing table.

Accordion is similar to EpiChord except that maintenance traffic is budgeted based on available bandwidth for each peer. Accordion uses recursive parallel lookups so as to maintain fresh routing table entries in its neighborhood of the overlay and reduce the probability of timeout. The peer requesting the lookup selects destinations based on the key and also gaps in its routing table. Responses to forwarded lookups contain entries for these routing table gaps. Excess bandwidth in the peer's bandwidth budget is used for parallel exploratory lookups to obtain routing table entries for the largest scaled gaps in the peer's routing table. The degree of parallelism is dynamically adjusted based on the level of lookup traffic and bandwidth budget, up to a maximum configuration such as 6-way. Replacing Accordion p-way forwarded and exploratory lookups with multi-destination lookups reduces edge traffic by (p−1)/2p; e.g., p=5 means 40% reduction on the edge. For a fixed bandwidth budget, this means that a peer can increase its exploration rate by factor of 2.5, substantially improving routing table accuracy. Alternately, a peer can operate at the same level of routing table accuracy (and number of hops per lookup) for a lower bandwidth budget.

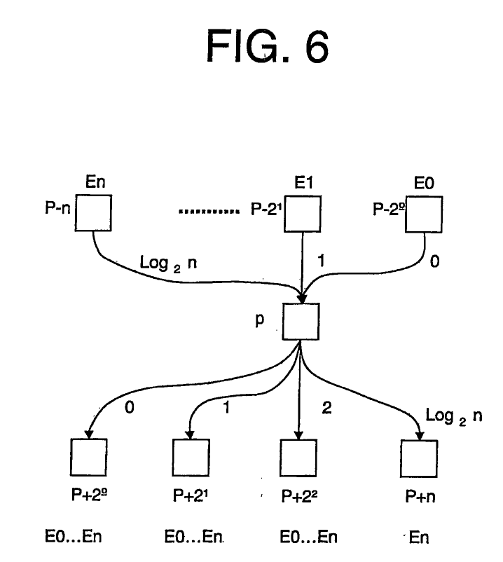

D1HT is a one-hop overlay that defines the overlay maintenance algorithm EDRA (Event Detection and Reporting Algorithm), where an event is any join/leave action. EDRA propagates all events throughout the system in logarithmic time. Each join/leave event is forwarded to log₂(x) successor peers at relative positions log₂(0) through log₂(n) as shown in FIG. 6. Following conventional notation, Θ is the interval at which a peer propagates events to its successors in the ring, and ρ=┌log₂ n┐ is the maximum number of messages a peer sends in the interval. Propagated events are those directly received as well as those received from predecessors since the last event message. Each message has a time to live (TTL) and is acknowledged. If there are no events to report, only messages with TTL=0 are sent.

During any interval Θ, a peer sends at most ρ=└log₂ n┐ messages containing its current events. Each message contains the same set of events but different TTL in the range [0 . . . ρ). We replace the p unicast messages with a ρ-way multi-destination packet containing the set of events and a list of [peer,TTL] pairs. Each peer receiving the message extracts its TTL from the list. At size n=10̂6, Chuang-Sirbu scaling law estimate gives 41.6% message reduction savings (ρ=20). At size n=10̂3, Chuang-Sirbu estimate gives 34% savings (ρ=10).

Random walk has been shown to be the most efficient search technique in unstructured topologies that are represented as power-law graphs. In a random walk, if an incoming query can not be locally matched, the request is forwarded to a randomly selected neighbor, excluding the neighbor from which the request was received. Systems using random walk include Gia and LMS. Multi-destination, multicast routing can be used at the initial node in a parallel random walk to reduce edge traffic as well as some internal traffic. It can also be used in subsequent hops.

Several peer-to-peer overlays support a type of application layer multicasting in which nodes in the overlay network forward data packets to children nodes in a multicast tree. Multicast trees define the data paths between nodes in the overlay network. Multicast trees are formed by considering constraints on the in-degree and out-degree of nodes. Since the nodes typically use unicast links to connect parent and children nodes, each link uses bandwidth on the node's network interface. To accommodate the limited branching factor permitted at each node generally increases path length in the tree, leading to larger end-to-end latency. Various protocols for constructing and maintaining these types of multicast trees are known in the art.

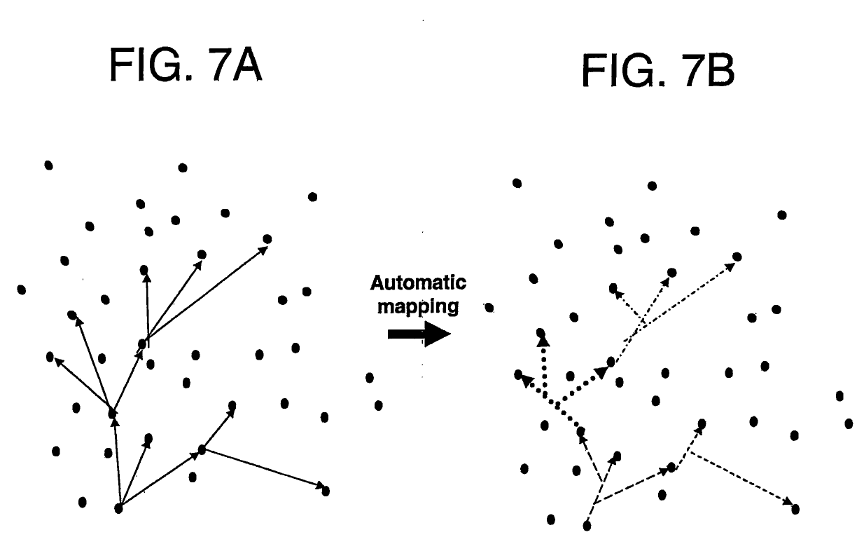

A new messaging scheme is proposed that uses a multi-destination, multicast routing protocol to transmit data packets amongst the nodes in the multicast tree. To do so, the nodes in the overlay network are configured to forward data packets in accordance with a multi-destination, multicast routing protocol. Data packets may then be transmitted between nodes in accordance with a multicast tree using the multi-destination, multicast routing protocol. FIGS. 7A and 7B provide a comparison between the conventional scheme and the newly proposed messaging scheme. In FIG. 7A, a data packet is sent using a conventional unicast approach; whereas, in FIG. 7B, a data packet is sent using a multi-destination, multicast routing protocol. Thus, the content to many out-going links on a node can be carried in a single sequence of multi-destination addressed packets. In general, the out-degree of the multi-destination routing nodes can be much higher, leading to lower latency multicast trees compared to the conventional approach.

Further this integration of multi-destination, multicast routing means that the size limit of multi-destination routing can be overcome. Suppose a multi-destination packet is limited to a maximum of 50 destinations and each node is constrained to say C number of connections. Nevertheless we can form overlay trees of millions of nodes where each node connects to at most C*50 out-going nodes. Each node receiving a single incoming packet forwards it using a the set of address which corresponding to its adjacencies. The root of the tree can connect to C*50 children nodes. Each of these in turn can connect to up to C*50 children using separate multi-destination packets. At the third level of the tree is a potential fanout of (C*50)̂3. If C=2, that is 10̂6 nodes addressable in a tree of height 3.

In yet another example, some distributed hash tables (DHT) support location-based searches. For example, applications may search for services or information related to a specific location, such as a latitude-longitude position. A grid is often used to correlate multiple locations to a single identifier. For a specific location, the grid is referenced to find the nearest grid point to the location. The location data (e.g., mailing address, postal code, latitude-longitude position, etc.) for the grid point is then used as the key to access the DHT. In some instances, multiple points on the grid are queried in parallel. For instance, if one wants to search for services in a larger area than a single grid point, then one queries a neighborhood of grid points in the given area. Rather than send a unicast message to each grid point, it is proposed to use multi-destination, multicast routing protocol to query a set of adjacent grid points.

This technique may be particular suited for locating a service discovery mechanism. A service discovery mechanism of any type may support specific protocols for discovery, advertisement and invocation. It may also support specific service description formats and semantics. A service discovery mechanism may be administered within a network administration domain and has a type which defines its protocols and formats. Exemplary types include SLP, UDDI and LDAP. It is envisioned that DHTs may be used to locate service discovery mechanisms of interest within a peer-to-peer environment. Further details regarding this technique may be found in U.S. Provisional Patent Application No. 60/715,388 filed on Sep. 8, 2005 which is incorporated herein by reference.

A non-empty set of identifiers may be concatenated and used as input to a DHT. Each such key and reference to a service discovery mechanism is inserted in the DHT. The reference to the DHT may be a description of the service discovery mechanism and its access method, a URI, or a software interface for communicating with service discovery mechanism. More than one key may be inserted into the DHT for a given service discovery mechanism, thereby supporting different ways of searching for the mechanism. As is the practice, an identifier may be segmented and each segment individually inserted into the DHT. This supports wild card and full-text retrieval lookup in certain DHT-based-systems.

A service discovery mechanism may also have other attributes such as location of the domain or location of services administered by the domain. In these instances, location-based searches of DHTs may be used to locate a suitable service discovery mechanism. A plurality of grid points near the location of interest may be queried using a multi-destination, multicast routing protocol as discussed above. In this way, a peer can discover a service discovery mechanism based on location.

Once again, only a few exemplary overlay operations have been described above. It is readily understood that the multi-destination, multicast routing protocol described above may be applied to other overlay operations having parallel messaging schemes. The following description is merely exemplary in nature and is not intended to limit the present disclosure, application, or uses.

What is claimed is:

1. A method for parallelizing overlay operations in an overlay network, comprising:
identifying an overlay operation having a parallel messaging scheme;
determining a destination address for each message in the messaging scheme;
formatting a data packet with each of destination addresses; and
transmitting the data packet over the overlay network using a multi-destination, multicast routing protocol.

2. The method of claim 1 further comprises transmitting the data packet in accordance with the Explicit Multicast (Xcast) protocol.

3. The method of claim 1 further comprises receiving the data packet at a routing device and forwarding the data packet using a multi-destination, multicast routing protocol.

4. The method of claim 3 wherein forwarding the data packet further comprises
identifying a next hop for each of the destination addresses in the data packet;
replicating the data packet for each identified next hop;
modifying the destination addresses listed in each data packet so that each data packet only contains the destination addresses which are to be routed through the next hop associated with the data packet; and
forwarding each modified data packet to an applicable next hop.

5. The method of claim 1 further comprises
defining an outgoing message queue at a node in the overlay network;
adding messages to the queue which are associated with an overlay operation;
identifying messages in the queue having different destinations within the overlay network but contain overlapping content;
combining the identified messages into a single data packet prior to transmitting the data packet over the overlay network.

6. The method of claim 5 wherein combining the identified messages further comprises formatting a destination address for each of the different destinations into a header of the data packet.

7. A method for parallelizing overlay operations in an overlay network, comprising:
defining an outgoing message queue at a node in the overlay network;
adding messages to the queue;
identifying messages in the queue having different destinations within the overlay network but containing overlapping content;
combining the identified messages into a single multicast data packet; and
transmitting the multicast data packet from the node using a multi-destination, multicast routing protocol.

8. The method of claim 7 wherein combining the identified messages further comprises encoding a destination address for each of the different destinations into a header of the data packet.

9. The method of claim 8 further comprises combining the identified messages unless the list of destination addresses exceeds a size limit

10. The method of claim 7 further comprises combining the identified messages unless a payload of the data packet exceeds a size limit.

11. The method of claim 7 further comprises transmitting a message in the queue using a unicast routing protocol when a maximum queueing delay metric associated with the message is exceeded.

12. The method of claim 7 further comprises transmitting messages which do not contain overlapping content using a unicast routing protocol.

13. The method of claim 7 further comprises transmitting the data packet in accordance with the Explicit Multicast (Xcast) protocol.

14. A messaging scheme for an overlay network, comprising:
a host node in the overlay network operable to perform at least one overlay operation having parallel messages, wherein the host node determines a destination address for each parallel message, encodes each destination address into a single data packet and transmits the data packet using a multi-destination, multicast routing protocol; and
a plurality of routers residing in an underlying network and operable to forward the data packet to each destination address in accordance with the multi-destination, multicast routing protocol.

15. The messaging scheme of claim 14 wherein each of the routers are adapted to receive the data packet and operable to identify a next hop for each of the destination addresses in the data packet, replicate the data packet for each identified next hop, modify the destination addresses listed in each data packet so that each data packet only contains the destination addresses which are to be routed through the next hop associated with the data packet, and forward each modified data packet to an applicable next hop.

16. The messaging scheme of claim 14 wherein the multi-destination, multicast routing protocol is further defined as Explicit Multicast (Xcast) protocol.

17. A messaging scheme for an overlay network having a plurality of nodes, comprising:
maintaining a hierarchical tree structure that defines data paths between nodes in the overlay network;
configuring nodes in the overlay network to forward data packets in accordance with a multi-destination, multicast routing protocol; and
transmitting data packets between nodes in accordance with the hierarchical tree structure using the multi-destination, multicast routing protocol.

18. The messaging scheme of claim 17, wherein the multi-destination, multicast routing protocol is further defined as the Explicit Multicast (Xcast) protocol.
